(19) United States
(12) Patent Application Publication
(10) Pub. No.: US 2026/0169455 A1
(43) Pub. Date: Jun. 18, 2026

(54) Method for Operating a Virtual Programmable Logic Controller

(71) Applicant: Siemens Aktiengesellschaft, Muenchen (DE)

(72) Inventors: Ronny HOG, Amberg (DE); Julia SCHWEIGER, Amberg (DE); Sebastian SCHÖTZ, Amberg (DE); Markus WALTER, Erlangen (DE)

(21) Appl. No.: 19/418,618

(22) Filed: Dec. 12, 2025

(30) Foreign Application Priority Data
Dec. 16, 2024 (EP) 24220219

(51) Int. Cl. G05B 19/05; G06F 8/70

(52) U.S. Cl. CPC G05B 19/056; G06F 8/70; G05B 2219/14006

(57) ABSTRACT

A method for operating a virtual programmable logic controller with a safety program on a first computer system and a virtual programmable logic controller with a safety program replicated from the safety program on a second computer system, wherein a management list image is generated by a central signature manager of the first computer system for the second computer system upon replication of the safety program for the second computer system, in order to ensure that, on the second computer system, which is, on an instance of the virtual programmable logic controller of the first computer system, the existing replicated safety program corresponds to the safety program on the first computer system.

### BACKGROUND OF THE INVENTION

1. Field of the Invention

The invention relates to a method for operating virtual programmable logic controllers (PLC), in particular, for safeguarding replicated safety programs in distributed systems.

### 2. Description of the Related Art

Modern industrial production processes usually represent a complex succession of individual steps whose accurate monitoring over time can be regarded as important in order to be able to enable an optimized manufacturing cycle. In particular, it can be regarded as important to determine and characterize a specific operating state (i.e., a state that can describe the manufacturing process in its entirety during a cycle).

With virtual programmable logic controllers (vPLCs) having safety programs, there exists the challenge of ensuring the correct replication and execution of the safety programs, in particular, if a switch-over to a backup system is needed.

A virtual programmable logic controller is a software-implementation of a classic PLC that is executed on an abstracted hardware platform. The main advantage of virtual controllers lies in their independence from specific controller hardware while simultaneously maintaining the full PLC functionality. This enables new flexible automation architectures.

A possible embodiment of a virtual programmable logic controller (vPLC) could be that the vPLC is caused to execute as a software instance in a containerized manner on a virtual machine. It can be instanced on available platforms as often as desired and contains the complete PLC functionality including real time capability and can communicate with field devices via Ethernet ports. It enables a flexible scaling and distribution of the control functions. It can also be realized as a safety PLC on the basis of coding processing via software.

The safety PLC executes on a virtual machine on standard IT hardware or industrial PCs. The safety PLC on virtual machines enables a flexible allocation of computation and storage resources. The virtual embodiment offers advantages such as hardware independence, simple deployment, central management and flexible scaling. At the same time, the real time capability and safety functions are retained.

### SUMMARY OF THE INVENTION

It is an object of the present invention to provide a method that implements a safeguarding of replicated safety programs for virtual programmable logic controllers so as to ensure that a safety program, executing on a virtual PLC and possibly replicated on a plurality of instances, is executed correctly and safely.

This and other objects and advantages are achieved in accordance with the invention by a method for operating a virtual programmable logic controller with a safety program on a first computer system and a virtual programmable logic controller with a safety program replicated from the safety program on a second computer system.

In the event that the first computer system and/or the virtual programmable logic controller running thereon drops out, switch-over takes place to the second computer system and/or to the virtual programmable logic controller installed thereon with the replicated safety program.

A central signature manager is operated in which a signature and a time stamp of the safety program are entered into a management list. In the case of a change to the safety program on the first computer system, the correspondingly changed signature and the changed time stamp are entered into the management list.

The central signature manager is further operated to write the signature and the time stamp in a control data area of the virtual programmable logic controller.

In order to ensure that, on the second computer system, which is, on an instance of the virtual programmable logic controller of the first computer system, the existing replicated safety program corresponds to the safety program on the first computer system, upon replication of the safety program for the second computer system, a management list image is generated by the central signature manager of the first computer system for the second computer system and is cyclically updated by the central signature manager of the first computer system.

A checking routine is operated on the programmable logic controller on the second computer system, which compares the signature and the time stamp from the control data area with the signature and the time stamp from the management list image.

In the event that switch-over to the second computer system occurs, a start process of the instance of the virtual programmable logic controller is implemented to execute the replicated safety program on the second computer system only when the signatures and time stamps match.

In some embodiments, the central signature manager can be operated on a separate computer system that is independent of the first and second computer systems.

The update of the management list image can occur in pre-defined time intervals.

The checking routine on the second computer system can be performed at regular intervals to ensure the consistency between the replicated safety program and the safety program.

If the signatures and time stamps do not match, then an update of the replicated safety program can be initiated on the second computer system. The signature can be generated via a cryptographic method.

The central signature manager can implement a version management for the safety program and the replicated safety program.

Upon switching over to the second computer system, a notification can be sent to a system administrator.

The first computer system and the second computer system can be operated in separate physical locations.

The communication between the first computer system, the second computer system and the central signature manager can occur via an encrypted connection.

Upon initiation of a run procedure in the instance of the virtual programmable logic controller on the second computer system, a check can be initially performed to determine whether program signatures and time stamps are present in the control data area of the instance. Given the presence of program signatures and time stamps in the control data area, the program signature in the control data area can be set to an initial value and the time stamp of the safety program can be set equal to the time stamp from the control data area.

A check can be subsequently performed to determine whether a program signature of the safety program is present. If the program signature of the safety program is present, then a check can be performed cyclically, until a predefined timeout, to determine whether the program signature has been written in the control data area of the central signature manager. If the timeout is exceeded, then the virtual programmable logic controller can be placed in a stop state with a corresponding diagnosis. If the program signature is written in the control data area via the central signature manager within the timeout, then a check can be performed to determine whether the time stamp in the control data area matches the time stamp of the safety program.

If the time stamps match, then the virtual programmable logic controller can start up. If the time stamps do not match, then the virtual programmable logic controller can be placed in a stop state with a corresponding diagnosis that a correct safety program is not present.

When an instance of the virtual programmable logic controller is ended or deactivated, a deletion procedure can be implemented on the first computer system or the second computer system. Therein, all the safety-relevant data including the safety program or the replicated safety program, the program signatures and the time stamps from the memory store of the relevant virtual programmable logic controller can be deleted.

The central signature manager can be informed about the deletion procedure and can remove the corresponding entries in the management list for the instance concerned or mark them as invalid. On a late reactivation of the instance, a complete new initialization and synchronization with the central signature manager can be performed to ensure the integrity and currency of the safety program or of the replicated safety program.

The checking routine can be operated within a run time environment of the virtual programmable logic controller. The run time environment can be implemented as firmware of the virtual programmable logic controller. The run time environment can implement the safety program or the replicated safety program and can manage the control data area in which the signature and the time stamp are stored.

An edge app can be installed in which the central signature manager for all the safety programs is operated in an edge system. The edge app can manage the management list with the program signatures and the time stamps for all the connected fail-safe virtual PLCs. The edge app can perform a data management that stores and updates program signatures and time stamps for each safety program.

The edge app can operate a communicator that reads from and writes to the storage area for the signatures and time stamps and the control area for these within the safety vPLC. The edge app can represent a central management instance for the safety and integrity of all safety programs in the edge system.

In sum, the method in accordance with the invention enables a secure and reliable replication and execution of safety programs in virtual programmable logic controllers. With the use of signatures, time stamps and a central management system, it is possible to ensure that upon switching over to a backup system, the correct and current version of the safety program is always performed. The checking routine on the second computer system can therein check the consistency between the replicated safety program and the original safety program at regular intervals to ensure the integrity of the system. In some cases, the checking routine can also prevent a start-up if matching of the signatures and the time stamp is not ascertained. The management list image and the control data area can therein play an important role to ensure the consistency and currency of the safety program.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The drawings illustrate exemplary embodiments of the invention, in which:

FIG. 1 shows a schematically represented mechanism for realizing a safeguarding of replicated safety programs of a plurality of instances of the safety vPLCs on a second computer system in accordance with the invention;

FIG. 2 shows a schematically represented mechanism to illustrate a switch-over from the first to the second computer system in accordance with the invention;

FIG. 3 shows a schematically represented mechanism for realizing safeguarding of replicated safety programs on a plurality of further computer systems in accordance with the invention;

FIG. 4 shows periodical processing on a central signature manager in accordance with the invention;

FIG. 5 shows a flow diagram of a start-up of a virtual PLC instance in accordance with the invention; and

FIG. 6 shows a further mechanism for realizing a safeguarding of replicated safety programs in accordance with the invention.

### DETAILED DESCRIPTION OF THE EXEMPLARY EMBODIMENTS

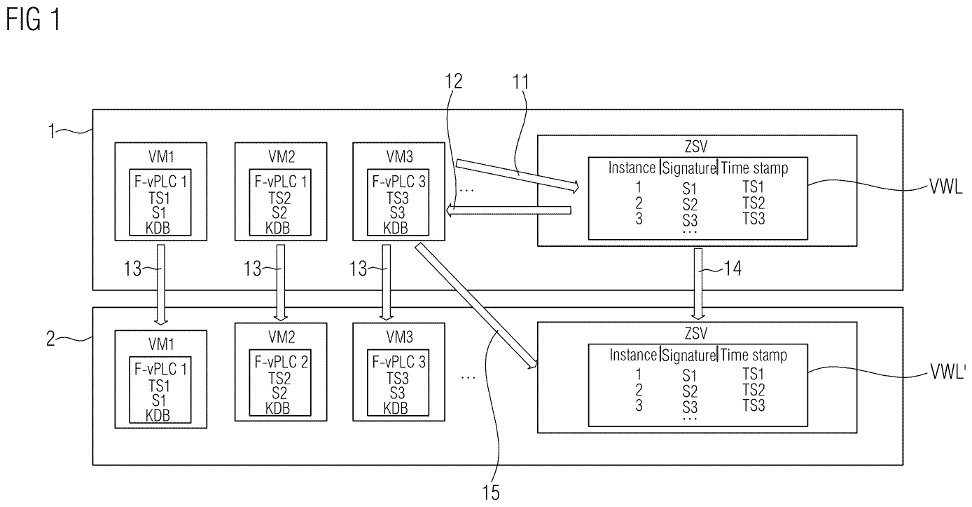

FIG. 1 shows a redundant server system for managing virtual programmable logic controllers vPLCs, in particular, fail-safe virtual programmable logic controllers F-vPLCs in a distributed environment. The system comprises a first computer system 1 configured as a server with active virtual machines VM1 to VMn and a second computer system 2 configured as a replica server with standby virtual machines VM1 to VMn.

The first computer system 1 with active virtual machines VM1 to VMn contains a plurality of virtual machines each of which hosts a fail-safe vPLC, specifically an F-vPLC. Each virtual machine VM1 contains a time stamp, a signature and a control data area KDB. Accordingly, the first fail-safe virtual programmable logic controller F-vPLC1 contains a first signature S1, a first time stamp TS1 and a control data area KDB, etc. Apart from the active server, there is a central signature manager component ZSV. This component contains a table with instance recognitions, corresponding signatures and time stamps for each FvPLC instance.

The replica server, i. e, the second computer system 2 with the standby virtual machines VM1 to VMn, replicates the structure of the active server that has corresponding VMs, specifically F-vPLC1, F-vPLC2, F-vPLC3, . . . , with their respective F-vPLCs, time stamps, specifically TS1, TS2, TS3, . . . , signatures, specifically S1, S2, S3, . . . , and a control data area KDB in each case.

The central signature manager ZSV is operated to enter a signature S1 and a time stamp TS1 into a management list VWL, where the correspondingly changed signature S1 and the changed time stamp TS1 are entered into the management list VWL in the case of a change to the safety program F-Prog on the first computer system 1. Via a reading-in step 11, the central signature manager ZSV then receives all the signatures and time stamps of the existing virtual machines VM1, VM2, VM3. Therefore, the virtual machines and their associated instances are entered into the management list VWL. In a write-back step 12, the central signature manager ZSV is operated such that the signatures are written back into the control data area KDB of the instances, both in the first computer system 1 and also in the second computer system 2.

In a replication step 13, the virtual machines VM1, VM2, VM3 with their virtual fail-safe controllers F-VPLC1, F-VPLC2 and F-VPLC3 are transferred from the first computer system 1 to the second computer system 2 as a replication.

Upon replication of the safety program F-Prog or on replication of the virtual machines VM1, VM2, VM3, a management list image VWL′ is generated by the central signature manager ZSV of the first computer system 1 for the second computer system 2 and is cyclically updated by the central signature manager ZSV of the first computer system 1 in an imaging step 14. In the event that switch-over from the first computer system 1 to the second computer system 2 occurs, a start process of the corresponding instance of the virtual programmable logic controller F-vPLC is performed to execute the replicated safety program rF-Prog on the second computer system 2 only when the signatures and time stamps match. If a safety program F-Prog becomes changed in an F-vPLC, then in a deleting step 15, then the management list image VWL′ is deleted and is then generated anew by way of the imaging step 14.

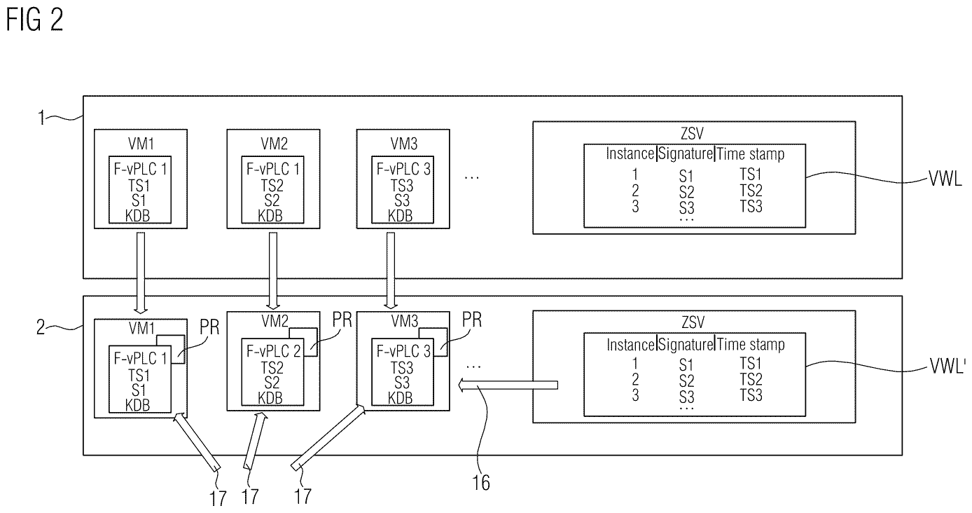

The switch-over from the first computer system 1 to the second computer system 2 is shown in FIG. 2. In order to ensure that the replicated safety programs F-Prog have no errors, a checking routine PR is operated on the corresponding fail-safe programmable logic controllers F-vPLCs on the second computer system 2. The execution of the checking routine PR is symbolized by the checking mechanism 17. In a safety step 16, before the checking, all the signatures are periodically written back from the management list image VWL′ into the corresponding replicated virtual machines VM1, VM2, VM3 or into the fail-safe virtual controllers F-vPLCs.

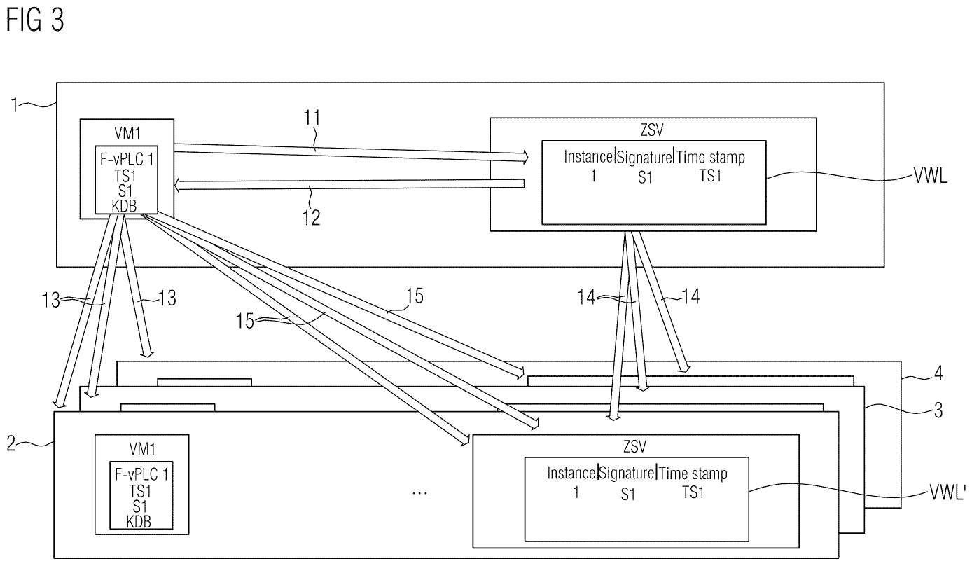

FIG. 3 shows a further possibility for replicating virtual machines VMs or virtual programmable logic controllers T-vPLC. In each case, a virtual machine VM1 is replicated from a first computer system 1 to a second computer system 2, a third computer system 3, . . . up to an nth computer system. Thus, a first replica server 1, a second replica server 2, . . . up to an nth replica server n come about. On the first computer system 1, as before in a reading-in step 11, the central signature manager ZSV is filled with signature S1 and time stamp TS1. In a write-back step 12, the signature S1 and the time stamp TS1 are written back into the control data area KDB. Upon replication of the individual virtual machines VM1, a management list image VWL′ is now written into each instance via the imaging step 14. If a new safety program F-Prog is now loaded on the first computer system 1, then via a deleting step 15, a deletion of the data is requested in each replica of the central signature manager ZSV or in the management list images VWL′. This can be performed, for example, by a user via a script.

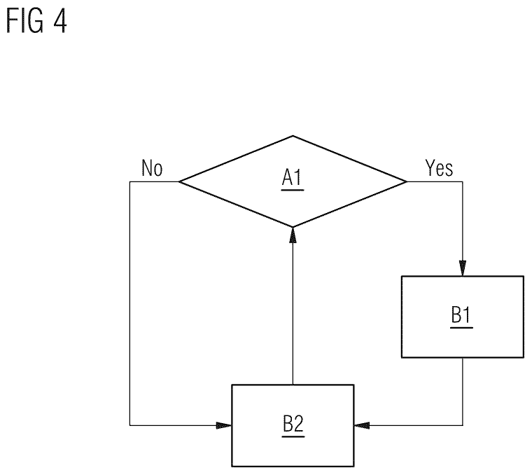

FIG. 4 shows a periodic processing of the central signature manager ZSV. In a first query A1, a check is performed to determine whether a program ID, i.e., for example, a program signature S1 has become changed on an instance of the virtual programmable logic controller vPLC. If this is the case, then the signature and the time stamp are updated for the respective instance on the central signature manager ZSV. Thereafter, all the program signatures and time stamps are always written back into the control data area KDB of each instance.

The decision-making process for management a virtual programmable logic controller vPLC comprises a series of steps and decisions. At the start of the process, a decision A1 is made. This decision A1 can be based upon various factors that are related to the operation or the configuration of the vPLC.

If the result of the decision A1 is positive, then a step B1 is performed. Step B1 can include the performance of a particular action or a series of actions related to the vPLC management. These actions can comprise, for example, the updating of configuration parameters, the checking of the system integrity or the initiating of a particular operating mode.

Regardless of the result of the decision A1, the process passes to a step B2. Step B2 is performed regardless of whether step B1 has been performed. Step B2 can contain additional actions or checks in relation to the vPLC management process.

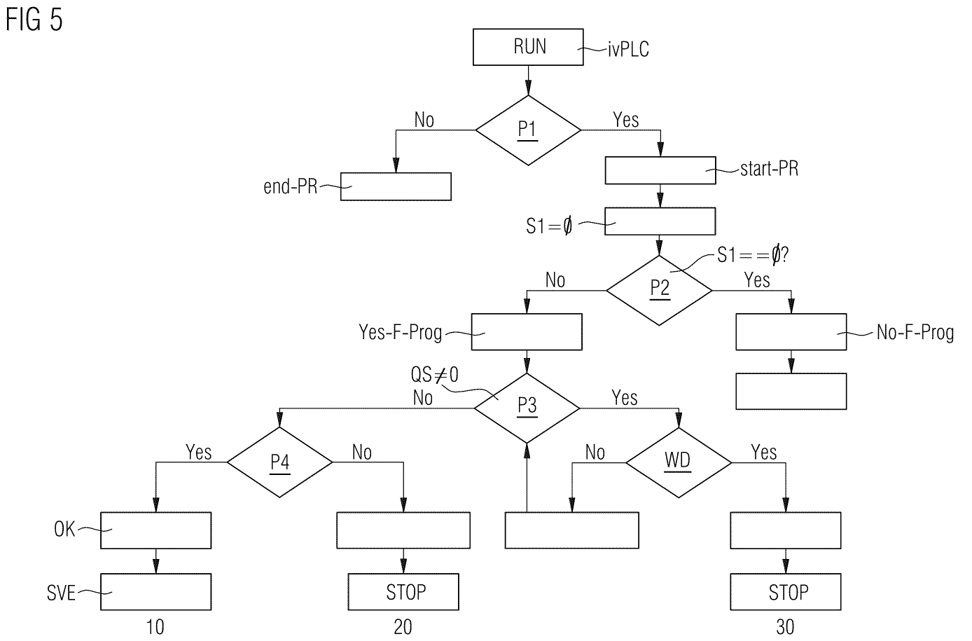

FIG. 5 shows a sequence on start-up of a virtual programmable logic controller ivPLC and/or F-vPLC. It starts with the initiation of a run procedure RUN in the instance of the virtual programmable logic controller vPLC. In a first check P1, a checked is performed to determine whether program signatures S and time stamps TS are present at all in the control area of the instance, and thus a check is performed to determine whether, for this instance of the virtual programmable logic controller vPLC, a replication concept is present at all. If this is not the case, then it is assumed that no replication concept is available and the vPLC starts up, although if the aforementioned program signatures S1 and the corresponding time stamps TS1 are present in the control data area KDB, then it is assumed that a replication concept is available.

The program signature in the control area receives the initial value 0 and the time stamp of the F-program is set equal to the time stamp from the control area. A check is then performed to determine whether a program signature of the F-program is present. If this is equal to 0, then no F-program is loaded and the vPLC starts up. If an F-program is loaded, then a check is performed to determine whether the initial value of the program signature in the control area has already been written by the central signature management means ZSV. If this is not the case, then a is performed cyclically until a particular timeout.

If the timeout is exceeded, then the vPLC enters a STOP with a corresponding diagnosis. If the program signature is written in the control area within the timeout by the central signature manager ZSV, then a check is subsequently performed to determine whether the time stamp in the control data area KDB matches the time stamp of the F-Progr and if they match, then the correct F-program is present in the replica and the vPLC starts up. If the two time stamps differ, then the vPLC enters a STOP with a corresponding diagnosis that it is not a correct F-Prog.

The process for checking with the checking routine PR in a virtual programmable logic controller vPLC therefore comprises a plurality of steps and decision points. A vPLC application starts in the “RUN” state and passes into a step P1. In step P1, a condition is checked. If the condition is not met, then the process changes into the state “end-PR”. If the condition is met, then the process changes into the state “start-PR”.

Following the state “start-PR”, the process reaches a step P2. At step P2, a check is performed to determine whether a particular condition is true. If the condition is true, then the process changes into the state “No F-Prog”. If the condition is false, then the process changes into the state “Yes-F-Prog”.

Following the state “Yes-F-Prog”, the process reaches a step P3. In step P3, a plurality of conditions are checked. If these conditions are met, then the process passes to a step P4. If the conditions are not met at step P3, then the process changes to a watchdog decision step.

In the watchdog step, the process changes into a “STOP” state that is labeled as identifier 30 if a condition is met. If the watchdog condition is not met, then the process reverts to step P3.

At step P4, the process changes into an “OK” state that is followed by an “SVE” state that are both labeled as identifier 10 if a condition is met. If the condition at step P4 is not met, then the process changes into a “STOP” state that is labeled as identifier 20.

Upon switch-over to a replica virtual machine VM or upon start of a replica, the vPLC application starts and the firmware checks whether signatures and time stamps match. The vPLC can possibly only begin with the execution of the safety program if the signatures and time stamp match.

This checking process can ensure the integrity and consistency of the safety program across different instances of the vPLC.

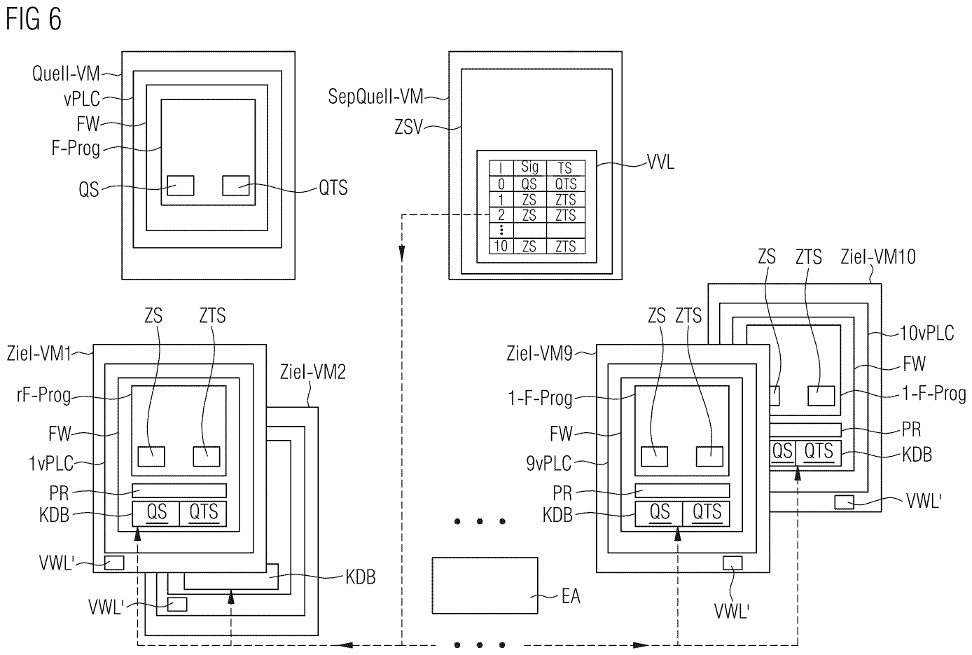

FIG. 6 shows an example that could be applied to series-production machines. A source virtual machine Quell-VM, a separate source virtual machine sepQuell-VM and a plurality of target virtual machines Ziel-VM1, . . . , Ziel-Vm10 are shown. In the source virtual machine Quell-VM, a virtual programmable logic controller vPLC is implemented. Located within this virtual programmable logic controller vPLC is a run time environment FW. In the run time environment FW, which can also be regarded as a firmware of the virtual programmable logic controller vPLC, a safety program F-Prog is present. Associated with the safety program F-Prog is a source program signature QS and a source time stamp QTS. In order to secure the correct data replications, a central signature manager ZSV is operated on the separate source virtual machine sepQuell-VM. The signature manager ZSV is configured such that it can manage the source program signature QS, the source time stamp QTS and at least one target program signature ZS and at least one target time stamp ZTS in a management list VVL.

In the example shown in FIG. 6, the management list VVL manages a total of ten virtual machines, specifically a first target virtual machine Ziel-VM1 through to a tenth target virtual machine Ziel-VM10. The management list VVL is constructed with three columns. In a first column, an instance I from 0 to 10 is entered. In a second column, the signature of the program is entered. In a third column, the respective time stamp TS of the program is entered. The instance i is given here, for example, from 0 to 10, where i=0 means that it is the original source or the safety program F-Prog of the source virtual machine Quell-VM. i=1 means the first instance of the virtual programmable logic controller, up to i=10 for the tenth instance of the virtual programmable logic controller.

If a safety program F-Prog is now replicated from the source virtual machine Quell-VM to a target virtual machine Ziel-VM, then the replicated safety program rF-Prog is provided in an instance of the virtual programmable logic controller iv-PLC. The first target virtual machine Ziel-VM1 has thus received a replicated safety program RF-Prog. In the replicated safety program rF-Prog there is a target program signature ZS and a target time stamp ZTS. The central signature manager ZSV is configured to write the source program signature QS and the source time stamp QTS from the “original” program into the virtual machines. The periodic writing of the source program signature QS and of the source time stamp QTS occurs in a control data area KDB of the corresponding instances of the virtual programmable logic controller ivPLC with the respective associated corresponding replicated safety program rF-Prog onto the respective target virtual machine Ziel-VM.

In each run time environment FB of a respective target virtual machine Ziel-VM1, . . . , Ziel-VM10, a checking routine PR is present. The checking routine PR is operated on each target virtual machine Ziel-VM such that it compares the source program signature QS and the source time stamp QTS from the control data area KDB with the target program signature ZS and the target time stamp ZTS of the replicated safety program rF-Prog. Furthermore, the checking routine PR is configured so that if the signatures and time stamps match, a start process of the instance of the virtual programmable logic controller ivPLC to execute the replicated safety program rF-Prog on the target virtual machine Ziel-VM is permitted.

It is also possible that an edge application EA, such as an S7 connector or a modified version thereof, manages the signatures for the connected F-vPLCs. This application possibly interacts with the central signature management system to maintain current signature information for each vPLC instance.

The system shows connections between the SepQuell-VM and the other VMs, represented by dashed lines. These connections can represent the flow of signature and time stamp information between the central management components and the individual VMs and enable a synchronization and checking of safety programs in the distributed environment.

The centralized nature of the central signature manager ZSV can offer a plurality of advantages. Firstly, the system can possibly easily recognize discrepancies or unauthorized changes in the safety programs because it compares the stored signatures with the current state of each vPLC. Secondly, the time stamps can enable the system to identify when changes have occurred and possibly set them back to earlier known good states. Finally, the centralized approach can simplify the management and synchronization of safety-relevant program data across a plurality of virtual PLCs and thus improve the overall reliability and consistency of the control system.

In each VM, a safety program is also present. This safety program can contain the specific logic and instructions that have been developed in order to ensure the reliable operation of the controlled process or the equipment.

The program run time component within the VM possibly makes the execution environment available for the safety program. The program run time can interpret and execute the instructions defined in the safety program.

Each VM also contains a control database. This database can store configuration data, parameters and other information that is needed for the operation of the vPLC and the execution of the safety program.

The combination of these components within each VM can enable the creation of a fully functional virtual programmable logic controller, which runs independently in the virtual machine or machines VM.

Thus, while there have been shown, described and pointed out fundamental novel features of the invention as applied to a preferred embodiment thereof, it will be understood that various omissions and substitutions and changes in the form and details of the methods described may be made by those skilled in the art without departing from the spirit of the invention. For example, it is expressly intended that all combinations of those method steps that perform substantially the same function in substantially the same way to achieve the same results are within the scope of the invention. Moreover, it should be recognized that method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method for operating a virtual programmable logic controller with a safety program on a first computer system, and a virtual programmable logic controller with a safety program replicated from the safety program on a second computer system, a switch over to the second computer system or the virtual programmable logic controller installed thereon with the replicated safety program occurring in an event of at least one of the first computer system and the virtual programmable logic controller running thereon dropping, the method comprising:
operating a central signature manager in which a signature and a time stamp of the safety program are entered into a management list, a correspondingly changed signature and a changed time stamp being entered into the management list in cases of a change to the safety program on the first computer system;
operating the central signature manager to write the signature and the time stamp in a control data area of the virtual programmable logic controller;
generating a management list image by the central signature manager of the first computer system for the second computer system and cyclically updating the management list image by the central signature manager of the first computer system upon replication of the safety program for the second computer system to ensure that, on the second computer system, which is, on an instance of the virtual programmable logic controller of the first computer system, the existing replicated safety program corresponds to the safety program on the first computer system; and
operating a checking routine on the programmable logic controller on the second computer system, which compares the signature and the time stamp from the control data area with the signature and the time stamp from the management list image;
wherein in the event the switch over to the second computer system occurs, a start process of the instance of the virtual programmable logic controller is performed to execute the replicated safety program on the second computer system only when the signatures and time stamps match.

2. The method as claimed in claim 1, wherein the central signature manager is operated on a separate computer system which is independent of the first and second computer systems.

3. The method as claimed in claim 1, wherein said updating of the management list image occurs at predefined time intervals.

4. The method as claimed in claim 2, wherein said updating of the management list image occurs at predefined time intervals.

5. The method as claimed in claim 1, wherein said checking routine on the second computer system is implemented at regular intervals to ensure consistency between the replicated safety program and the safety program.

6. The method as claimed in claim 1, further comprising:
initiating an update of the replicated safety program is initiated on the second computer system if the signatures and time stamps fail to match.

7. The method as claimed in claim 1, wherein the signature is generated via a cryptographic method.

8. The method as claimed in claim 1, wherein the central signature manager implements version management for the safety program and the replicated safety program.

9. The method as claimed in claim 1, wherein a notification is sent to a system administrator upon switching over to the second computer system.

10. The method as claimed in claim 1, wherein the first and second computer systems are operated in separate physical locations.

11. The method as claimed in claim 1, wherein communication between the first computer system, the second computer system and the central signature manager occurs via an encrypted connection.

12. The method as claimed in claim 1, wherein upon initiation of a run procedure in the instance of the virtual programmable logic controller on the second computer system, a check is initially performed to determine whether program signatures and time stamps are present in the control data area of the instance;
wherein the program signature in the control data area is set to an initial value and the time stamp of the safety program is set equal to the time stamp from the control data area when program signatures and time stamps in the control data area are present;
performing a check to determine whether a program signature of the safety program is present;
performing a cyclically check, until a predefined timeout, to determine whether the program signature has been written in the control data area of the central signature manager if the program signature of the safety program is present;
placing the virtual programmable logic controller a stop state with a corresponding diagnosis if the timeout is exceeded;
performing, via the central signature manager within the timeout, a check to determine whether the time stamp in the control data area matches the time stamp of the safety program if the program signature is written in the control data area;
starting up the virtual programmable logic controller if the time stamps match; and
placing the virtual programmable logic controller into a stop state with a corresponding diagnosis that a correct safety program is not present if the time stamps do not match.

13. The method as claimed in claim 1, further comprising:
performing a deletion procedure on the first computer system or the second computer system when an instance of the virtual programmable logic controller is ended or deactivated;
wherein all the safety-relevant data including the safety program or the replicated safety program, the program signatures and the time stamp from the memory store of the relevant virtual programmable logic controller are deleted;
wherein the central signature manager is informed about the deletion procedure;
wherein the central signature manager removes corresponding entries in the management list for a relevant instance or marks the corresponding entries as invalid; and
wherein a complete new initialization and synchronization with the central signature manager is implemented to ensure integrity and currency of the safety program or the replicated safety program upon late reactivation of the relevant instance.

14. The method as claimed in claim 1, wherein the checking routine is operated within a run time environment of the virtual programmable logic controller;
wherein the run time environment is implemented as firmware of the virtual programmable logic controller;
wherein the run time environment implements the safety program or the replicated safety program; and
wherein the run time environment manages a control data area in which the signature and the time stamp are stored.

15. The method as claimed in claim 1, wherein an edge app is installed in which the central signature manager for all the safety programs is operated in an edge system;
wherein the edge app manages the management list with the program signatures and the time stamps for all the connected fail-safe virtual PLCs;
wherein the edge app implements data a management which stores and updates program signatures and time stamps for each safety program;
wherein the edge app operates a communicator which reads from and writes to a storage area of the signatures and time stamps and a control area of signatures and time stamps within the safety program; and
wherein the edge app represents a central management instance for safety and integrity of all safety programs in the edge system.
